(19) United States
(12) Patent Application Publication
(10) Pub. No.: US 2003/0046847 A1
(43) Pub. Date: Mar. 13, 2003

(54) Device for bulletining posters and the like

(76) Inventor: Yasunobu Yoshida, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/241,584

(22) Filed: Sep. 12, 2002

(30) Foreign Application Priority Data
Sep. 13, 2001 (JP) 2001-278345
Sep. 13, 2001 (JP) 2001-278346
Apr. 10, 2002 (JP) 2002-108275

(51) Int. Cl. G09F 1/00

(52) U.S. Cl. 40/717; 340/384.1; 40/124.03; 340/692; 434/308; 434/311; 434/317

(57) ABSTRACT

A device for bulletining posters and the like has a simple construction which eliminates the need for using a base plate, allowing individual posters and the like to be bulletined with an easy mounting operation. The device for bulletining posters and the like mounts an upper connection sheet 20 having a plurality of positioning stoppers 22 for positioning the upper edge of a poster or the like, P; a plurality of pasting portions 23 for being pasted to the upper edge back surface of the poster or the like, P; and a plurality of engaging pieces 24 for being engaged for connection with an upper leader sheet to be positioned thereabove or the poster or the like, P, to be positioned thereabove, and a lower connection sheet 30 having a plurality of positioning stoppers 32 for positioning the lower edge of the poster or the like, P; a plurality of pasting portions 33 for being pasted to the lower edge back surface of the poster or the like, P; and a plurality of engaging pieces 34 for being engaged for connection with a lower leader sheet to be positioned thereunder or the poster or the like, P, to be positioned thereunder onto the upper edge and the lower edge of individual posters or the like, P, respectively; disposes a desired number of posters or the like, P, between the upper leader sheet and the lower leader sheet such that they can be replaced with a new one; and raises or lowers the posters or the like, P, for bulletining.

### BACKGROUND OF THE INVENTION

1. Field of the Invention

The present invention relates to a device for bulletining posters and the like that has a novel configuration, displaying a variety of advertisements and the like appealing to the visual and aural senses on the surface for bulletining a variety of information, such as advertisement information.

2. Background

Conventionally, devices for bulletining posters and the like which rectangular pararellepiped cabinet is designed to be disposed on a sidewalk of a street, for example, and with which, in the opening provided in the cabinet, a piece or pieces of information, such as new product advertisement information and store guide information, or a variety of posters or the like are presented, being electrically selected or in the stationary mode, for being bulletined and visually identified by a large number of unspecified passers-by have been put to practical use.

3. Problems to be Solved by the Invention

(The First Problem to be Solved by the Present Invention and the First Purpose Thereof)

Conventional devices for bulletining a variety of posters and the like are configured only for bulletining a variety of information consisting merely of characters, images, and the like, therefore, they have presented a problem of that, so long as the opening in the cabinet of the bulletining device is not identified and viewed by a large number of unspecified passers-by, no effect of advertising is created.

Conventionally, various bulletining devices which provide appealing to not only the visual sense, but also to the aural sense have been in existence, but their construction and the like are complicated, and thus, they actually lack practicality.

The first purpose of the present invention is to provide a device for bulletining posters and the like that has been developed in consideration of the above-stated conventional situation, and thus improves the effect of advertising by appealing to the aural sense in addition to the effect of advertising by appealing to the visual sense, making it possible to give explanation by voice, which can also lead to labor saving.

(The Second Problem to be Solved by the Present Invention and the Second Purpose Thereof)

Conventional devices for bulletining a variety of information are configured only for bulletining a variety of information consisting merely of characters, images, and the like, therefore, they have presented a problem of that, so long as the opening in the cabinet of the information bulletining device is not identified and viewed by a large number of unspecified passers-by, no effect of advertising is created.

An information bulletining device which is configured such that a sheet in a continuous length having new product advertisement information, store guide information and the like is stretched across a pair of rollers, and is driven in the longitudinal direction by an electric mechanism using a motor is already known, however, with this device, the sheet supporting mechanism is unsatisfactory, and thus the sheet can have a slack or the like, resulting in the visibility of the guide information or the like on the sheet surface being deteriorated, therefore the effect of advertising being lowered.

The second purpose of the present invention is to provide a device for bulletining posters and the like that has been developed in consideration of the above-stated conventional situation, and thus, can create an adequate effect of advertising by appealing to the visual sense by preventing the sheet surface from being slackened, and also appeal to the aural sense.

(The Third Problem to be Solved by the Present Invention and the Third Purpose Thereof)

With a device for bulletining posters and the like that is known, a poster or the like, 101, having a printed advertisement or the like is mounted on a base sheet 100 made of a plastic material in a continuous length, as shown in FIG. 17 and FIG. 18, and the base sheet 100 is wound up by turning an upper roller 103 or a lower roller 104 for bulletining the poster or the like, 101, having the printed advertisement or the like toward the visual identifier.

With such a conventional device for bulletining posters and the like, an elastic engaging piece 112 in the rhombus shape, for example, disposed in a mounting member 111 attached to the base sheet 100, for example, is engaged with an engaging hole 122 provided in a mounting member 121 attached to the poster or the like, 101, as shown in an enlarged view of FIG. 19, and by utilizing the elastic engagement of the engaging piece 112 with the engaging hole 122, and further using an adhesive tape as required, a desired number of posters or the like are mounted onto said base sheet 100.

However, the above-stated conventional device for bulletining posters and the like has presented problems of the configuration being complicated, and the operation of mounting a desired number of posters or the like, 101, being complex, more particularly, such problems as the base sheet 100 being indispensable; coil springs or the like being required to be added for providing a stretch across posters or the like, 101, for prevention of occurrence of a slack, distortion, and the like of the desired number of posters or the like, 101, mounted on the base sheet; and positioning of the desired number of posters or the like, 101, to be mounted on the base sheet 100 being difficult.

The third purpose of the present invention is to provide a device for bulletining posters and the like that has been developed in consideration of the above-stated conventional situation, and thus, has a simple configuration with no need for using a base sheet, allowing a desired number of posters or the like to be bulletined with an easy mounting operation.

### SUMMARY OF THE INVENTION

The invention as defined in claim 1 provides a device for bulletining posters and the like with which a sheet in a continuous length having a variety of information including advertisement information on respective pages on the sheet surface is presented in an opening provided in a cabinet, and this sheet is driven with sheet driving means along the longitudinal direction thereof for bulletining the variety of information on the respective pages in the area of said opening, comprising: page number detection means for detecting page number on said sheet surface; audio data recording means which records analog audio data related to said variety of information on the respective pages or other analog audio data; conversion data recording means which converts analog audio data related to the variety of information or other analog audio data sent from the audio data recording means into digital data, and records it as digital audio data; audio signal delivering means which, on the basis of page number detection signal from said page number detection means, reads out the digital audio data from the conversion data recording means, and delivers it as an audio signal; and pronouncing means which, on the basis of the audio signal from the audio signal delivering means, pronounces voice related to the pertinent page or other voice.

The invention as defined in claim 2 provides a device for bulletining posters and the like as claimed in claim 1, wherein said audio data recording means is recording means provided with a magnetic recording medium which stores voice as analog data, and said conversion data recording means is an IC memory which converts analog audio data into digital audio data, and records it.

According to the inventions as defined in claims 1 and 2, a variety of information on the respective pages for advertisement and the like is bulletined in the opening area, and the voice related to the pertinent page or other voice is pronounced by the pronouncing means, therefore, in addition to the effect of advertising by appealing to the visual sense of a large number of unspecified persons, such as passers-by, an effect of advertising by appealing to the aural sense can also be created, and a device for bulletining posters and the like that can enhance the effect of the advertisement can be realized. In addition, a magnetic recording medium which stores voice as analog data is provided, therefore, by previously recording advertisement information or the like on the magnetic recording medium by voice, a clear voice related to the respective page or other voice can be transmitted to the passers-by and the like. Thus, with the above-mentioned first problem being solved, the above-mentioned first purpose of the present invention can be achieved.

The invention as defined in claim 3 provides a device for bulletining posters and the like with which a sheet in a continuous length having a variety of information including advertisement information on the sheet surface is presented in an opening provided in a cabinet, and this sheet is supported, being stretched across a pair of rollers provided inside on both sides of the opening in said cabinet, with one roller being turned by a roller driving section for driving the sheet in the longitudinal direction thereof such that the variety of information on respective pages is bulletined in the region of said opening for visual guidance, wherein is provided a tensioning mechanism which comprises a permanent magnet plate with which N and S magnetic poles are alternately provided, and a magnetic substance plate which are fixed in proximity of the other of said pair of rollers; and a roller side magnetic substance plate which is attached to the end of said roller with a minute spacing from said permanent magnet plate being provided, such that forces in the direction which is opposite to the direction of sheet driving always act on the other roller of said pair of rollers for applying a tension to said sheet.

According to the invention as defined in claim 3, in bulletining a variety of information including advertisement information provided on the sheet in a continuous length in the opening area of the cabinet, the tensioning mechanism functions such that forces in the direction which is opposite to the direction of sheet driving always act on the other roller for applying a tension to said sheet, therefore, a device for bulletining posters and the like that can prevent the sheet surface from being slackened, and thus can create an adequate effect of advertising by appealing to the visual sense can be provided. Thus, with the above-mentioned second problem being solved, the above-mentioned second purpose of the present invention can be achieved.

The invention as defined in claim 4 provides a device for bulletining posters and the like with which a sheet in a continuous length having a variety of information including advertisement information on the sheet surface is presented in an opening provided in a cabinet, and this sheet is supported, being stretched across a pair of rollers provided inside on both sides of the opening in said cabinet, with one roller being turned by a roller driving section for driving the sheet in the longitudinal direction thereof such that the variety of information on respective pages is bulletined in the region of said opening for aural guidance, wherein is provided a tensioning mechanism which comprises a permanent magnet plate with which N and S magnetic poles are alternately provided, and a magnetic substance plate which are fixed in proximity of the other of said pair of rollers; and a roller side magnetic substance plate which is attached to the end of said roller with a minute spacing from said permanent magnet plate being provided, such that forces in the direction which is opposite to the direction of sheet driving always act on the other roller of said pair of rollers for applying a tension to said sheet.

According to the invention as defined in claim 4, in bulletining a variety of information including advertisement information provided on the sheet in a continuous length in the opening area of the cabinet, the tensioning mechanism functions such that forces in the direction which is opposite to the direction of sheet driving always act on the other roller for applying a tension to said sheet, therefore, a device for bulletining posters and the like that can prevent the sheet surface from being slackened, and thus can create an adequate effect of advertising by appealing to the visual sense, and that can also appeal to the aural sense can be provided. Thus, with the above-mentioned second problem being solved, the above-mentioned second purpose of the present invention can be achieved.

The invention as defined in claim 5 provides a device for bulletining posters and the like, wherein an upper connection sheet having a plurality of positioning stoppers formed in an approximately rectangular shape for positioning the upper edge of a poster or the like, a plurality of pasting portions which are to be pasted to the upper edge back surface of the poster or the like, and a plurality of engaging pieces for engaging for connection with an upper leader sheet to be disposed thereabove or the poster or the like to be disposed thereabove; and a lower connection sheet having a plurality of positioning stoppers formed in an approximately rectangular shape for positioning the lower edge of a poster or the like, a plurality of pasting portions which are to be pasted to the lower edge back surface of the poster or the like, and a plurality of engaging holes for engaging for connection with a lower leader sheet to be disposed thereunder or the poster or the like to be disposed thereunder; are mounted to the upper edge and the lower edge of an individual poster or the like, a desired number of posters or the like being disposed between the upper leader sheet and the lower leader sheet such that they can be replaced with a new one, and by winding up the upper leader sheet or the lower leader sheet, said posters or the like are raised or lowered for bulletining.

The invention as defined in claim 6 provides a device for bulletining posters and the like as claimed in claim 5, wherein said upper connection sheet comprises a sheet main body made of a thin sheet formed in an approximately rectangular shape; has a plurality of positioning stoppers which are capable of being opened and closed, serving to stop and position the upper edge of the poster or the like in the longitudinal direction; comprises a plurality of pasting portions each consisting of a double-sided adhesive tape which is to be pasted to the upper edge back surface of the poster or the like; and at the upper edge of the sheet main body, provides a plurality of flexible engaging pieces which have an approximately T shape, serving to engage for connection with the upper leader sheet to be disposed thereabove or the poster or the like to be disposed thereabove; and said lower connection sheet comprises a sheet main body made of a thin sheet formed in an approximately rectangular shape; has a plurality of positioning stoppers which are capable of being opened and closed, serving to stop and position the lower edge of the poster or the like in the longitudinal direction; comprises a plurality of-pasting portions each consisting of a double-sided adhesive tape which is to be pasted to the lower edge back surface of the poster or the like; and in the lower portion of the sheet main body provides a plurality of engaging holes which serve to engage for connection with the lower leader sheet to be disposed thereunder or the poster or the like to be disposed thereunder, more particularly, with which said engaging pieces of the upper connection sheet are capable of being engaged, with the plurality of engaging holes each being comprised of a pair of slits having a defined spacing between them in correspondence with the geometry of said engaging piece for the upper connection sheet that has an approximately T shape.

The invention as defined in claim 7 provides a device for bulletining posters and the like as claimed in claim 5 or 6, wherein said upper leader sheet is provided with engaging holes with which the engaging pieces for the upper connection sheet are to be engaged, and said lower leader sheet is provided with engaging pieces which are to be engaged with the engaging holes in the lower connection sheet.

According to the devices for bulletining posters and the like as defined in claims 5, 6, and 7, said upper connection sheet and lower connection sheet can be used to dispose a desired number of posters or the like between the upper leader sheet and the lower leader sheet such that they can be replaced with a new one, and by winding up the upper leader sheet or the lower leader sheet, said posters or the like can be raised or lowered for bulletining. In other words, the configuration is simple with no need for using a base sheet, and a desired number of posters or the like can be bulletined with an easy mounting operation. Thus, with the above-mentioned third problem being solved, the above-mentioned third purpose of the present invention can be achieved.

The invention as defined in claim 8 provides a device for bulletining posters and the like as claimed in any one of the claims 5 to 7, wherein, to said upper connection sheet or said lower connection sheet is attached a sensor marking which is detected by a positioning sensor disposed in the device main body for detection of the positions of the posters or the like.

According to the device for bulletining posters and the like as defined in claim 8, the positions of the posters or the like can be conveniently detected in addition to the action of said device as defined in any one of the claims 5 to 7.

### BRIEF DESCRIPTION OF THE DRAWINGS

FIG. 1 is a diagramatic plan view of a device for bulletining posters and the like according to an embodiment of the present invention for the first problem (the first purpose) or the second problem (the second purpose);

FIG. 2 is a diagramatic side view of the device for bulletining posters and the like according to the same embodiment of the present invention for the first problem (the first purpose) or the second problem (the second purpose);

FIG. 3 is a block diagram showing a control system for the device for bulletining posters and the like according to the same embodiment of the present invention for the first problem (the first purpose) or the second problem (the second purpose);

FIG. 4 is a perspective side view, with portions broken away for clarity, showing the configuration of a tensioning means for the device for bulletining posters and the like according to the same embodiment of the present invention for the first problem (the first purpose) or the second problem (the second purpose);

FIG. 5 is a perspective side view showing the appearance of a device for bulletining posters and the like according to an embodiment of the present invention for the third problem (the third purpose);

FIG. 6 is a perspective side view showing the device for bulletining posters and the like, with the front-cover opened, according to the same embodiment of the present invention for the third problem (the third purpose);

FIG. 7 is a schematic explanatory drawing showing the way of mounting a poster or the like to the upper connection sheet and the lower connection sheet for the device for bulletining posters and the like according to the same embodiment of the present invention for the third problem (the third purpose);

FIG. 8 is a schematic explanatory enlarged view showing the way of mounting a poster or the like to the upper connection sheet and the lower connection sheet for the device for bulletining posters and the like according to the same embodiment of the present invention for the third problem (the third purpose);

FIG. 9 is a perspective side view showing the process of disconnecting the lower leader sheet from the upper leader sheet for the device for bulletining posters and the like according to the same embodiment of the present invention for the third problem (the third purpose);

FIG. 10 is a perspective side view showing the process of mounting a poster or the like to the upper leader sheet for the device for bulletining posters and the like according to the same embodiment of the present invention for the third problem (the third purpose);

FIG. 11 is a perspective side view showing the process of mounting a poster or the like to the lower leader sheet for the device for bulletining posters and the like according to the same embodiment of the present invention for the third problem (the third purpose);

FIG. 12 is a perspective side view showing the condition before replacing a poster or the like with a new one for the device for bulletining posters and the like according to the same embodiment of the present invention for the third problem (the third purpose);

FIG. 13 is a perspective side view showing the way of disconnecting the lower connection sheet 230 for a poster or the like to be unloaded in replacement of poster or the like with new one for the device for bulletining posters and the like according to the same embodiment of the present invention for the third problem (the third purpose);

FIG. 14 is a perspective side view showing the way of disconnecting the upper connection sheet 220 for the poster or the like to be unloaded in replacement of poster or the like with new one for the device for bulletining posters and the like according to the same embodiment of the present invention for the third problem (the third purpose);

FIG. 15 is a perspective side view showing the way of mounting a new poster or the like to the upper connection sheet 220 for the device for bulletining posters and the like according to the same embodiment of the present invention for the third problem (the third purpose);

FIG. 16 is a perspective side view showing the way of mounting the new poster or the like to the lower connection sheet 230 for the device for bulletining posters and the like according to the same embodiment of the present invention for the third problem (the third purpose);

FIG. 17 is a schematic side view of a conventional device for bulletining posters and the like for the third problem (the third purpose);

FIG. 18 is a perspective side view showing the way of mounting a poster or the like to the base sheet of the same conventional device for bulletining posters and the like for the third problem (the third purpose); and

FIG. 19 is a partially enlarged view of the same conventional device for bulletining posters and the like.

### DESCRIPTION OF THE PREFERRED EMBODIMENTS

(Embodiment of the Present Invention for the First Problem and the First Purpose)

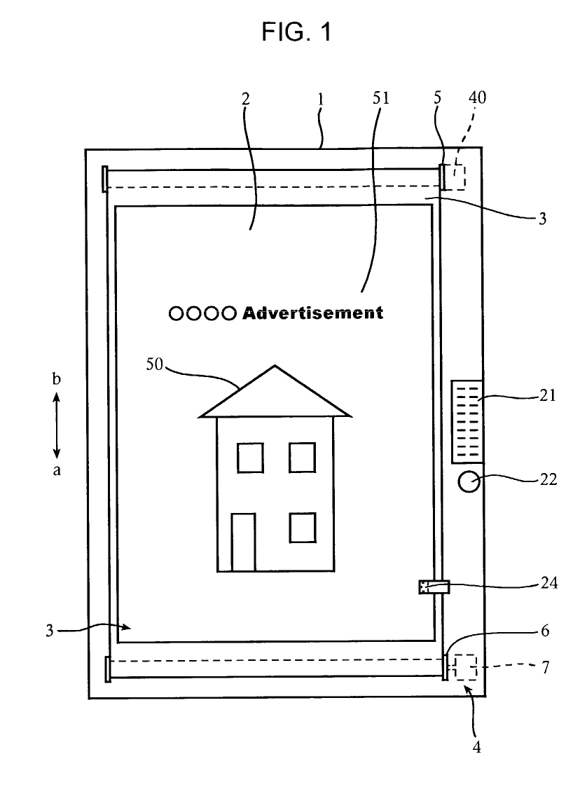

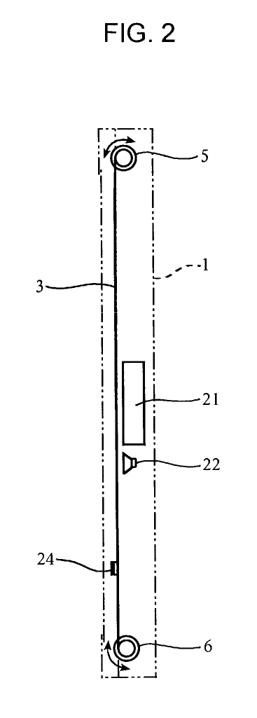

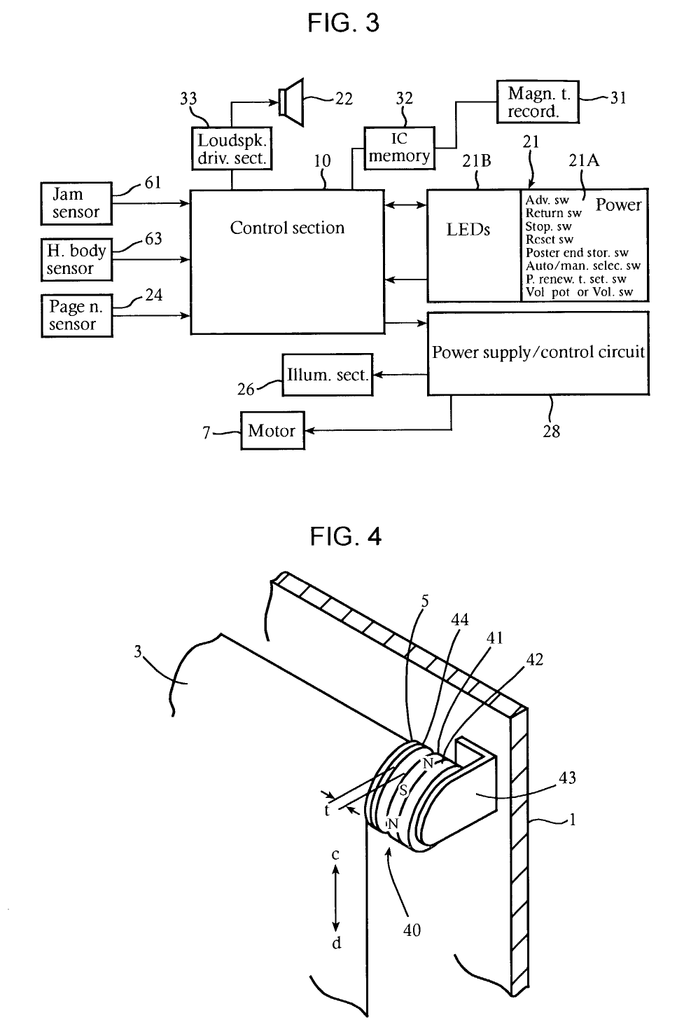

Hereinbelow, a device for bulletining posters and the like according to an embodiment of the present invention for the first problem and the first purpose will be described in details with reference to FIG. 1, FIG. 2 and FIG. 3.

The bulletining device according to the present embodiment as shown in FIG. 1, FIG. 2 and FIG. 3 is configured such that, in an opening 2 disposed in the front of a box-like cabinet 1, for example, a sheet 3 formed in the shape of a strip in a continuous length provided with a variety of information including advertisement information, such as an image of store, 50, together with guide characters 51, on the sheet surface, being divided into a desired number of pages, is presented, and by driving this sheet 3 up or down along the longitudinal direction thereof with a sheet driving means 4 incorporated in the cabinet 1, the variety of information on the sheet surface can be selectably bulletined page by page in the area of said opening 2.

Said sheet driving means 4 comprises rollers 5, 6 disposed in vertically opposed positions in the horizontal direction in FIG. 1 in the top and bottom areas of the inside of the cabinet 1, and a motor 7 connected to one roller 6, said sheet 3 being wound around the rollers 5, 6 and the motor 7 turning the roller 6 to drive said sheet 3 up or down along the opening 2.

A belt transmission mechanism (not shown) is disposed between the rollers 5, 6 for turning the roller 5 and the roller 6 in synchronization. Said roller 5 is provided with a tensioning mechanism 40 later described.

The cabinet 1 is provided with an operation section 21 for carrying out a variety of operations and a loudspeaker 22 as a pronouncing means which are located on the side of the opening 2.

The cabinet 1 is also provided with a page number sensor 24 as a page number detection means for scanning the respective pages on the sheet surface of the sheet 3, and detecting the character data, such as page 1 and page 2, which is previously given.

FIG. 3 shows a control system for the bulletining device, which has a control section 10 for controlling the entire device by taking in a page number signal read out by the page number sensor 24 which is operated in synchronization with the up or down movement of said sheet 3. In addition, said bulletining device is provided with an illuminating section 26 for illuminating the area of the opening 2 and a power supply/control circuit 28 which powers and controls said motor 7.

The bulletining device comprises a magnetic tape recorder 31 as an audio data recording means which records analog audio data related to said variety of information on the respective pages or other analog audio data; an IC memory 32 as a conversion data recording means which converts analog audio data related to said variety of information or other analog audio data sent from this magnetic tape recorder 31 into digital data, records it as digital audio data, and delivers it to said control section 10; a loudspeaker driving section 33 as an audio signal delivering means which, on the basis of the page number detection signal from said page number sensor 24, reads out the digital audio data for the pertinent page, converts it into an audio signal for delivery; and said loudspeaker 22.

Instead of said magnetic tape recorder 31, a variety of magnetic recording media, such as a magnetic disk (MD) and an IC recorder, which are capable of recording analog audio data may be used.

Instead of said IC memory 32, a variety of recording media, such as a CD-R, a CD-RW, and an MO, which are capable of digital recording may be used.

Further, said bulletining device is provided with a jam sensor 61 which detects jamming of said sheet 3, and a human body sensor 63.

Said operation section 21 comprises a switch section 21A and an indication section 21B, the switch section 21A having a power switch, an advancing switch for advancing a particular area (page) of said sheet 3, a return switch, a stopping switch, a reset switch, an auto/manual selector switch, a page renewing time setting switch, a poster end storing switch, a volume potentiometer (or a volume switch), and the like.

The indication section 21B is provided with LEDs which carry out power-on indication, poster page number indication, error indication and the like.

Next, said tensioning mechanism 40 will be described with reference to FIG. 4.

This tensioning mechanism 40 comprises a permanent magnet plate 41 with which N and S magnetic poles are alternately provided, and a magnetic substance plate 42, such as an iron plate, which are fixed to the cabinet 1 in proximity of said roller 5 by means of a support piece 43; and a roller side magnetic substance plate 44, such as an iron plate, which is attached to the end of said roller 5 with a minute spacing of “t” from said permanent magnet plate 41 being provided, such that the magnetic forces from the respective magnetic poles of the magnetic substance plate 42 act on the roller side magnetic substance plate 44, by which a tension in the direction of arrow “d”, which is opposite to the direction of arrow “c”, is always applied to the sheet 3 through said roller 5.

With the bulletining device according to the present embodiment, turning the power switch provided in the switch section 21A of the operation section 21, and then turning the advancing switch on will activate the power supply/control circuit 28, drive the motor 7, and run said sheet 3 in the direction of arrow “a” as shown in FIG. 1 under the control of the control section 10, by which said image of store, 50, and the guide characters 51 are displayed in the opening 2, an audio data recording section 23 being also run in the direction of arrow “a”.

At the same time, said sensor 24 scans the respective pages on the sheet surface of the sheet 3 for the character data, such as page 1 and page 2, which is previously given, and delivers the page number signal to the control section 10.

On the other hand, the analog audio data related to said variety of information or other analog audio data sent from said magnetic tape recorder 31 is recorded as digital audio data by the IC memory 32.

In accordance with the control by said control section 10, the loudspeaker driving section 33 reads out the digital audio data for the pertinent page from the IC memory 32 on the basis of the page number detection signal from said page number sensor 24, and converts it into an audio signal for delivering it to the loudspeaker 22.

As a result of this, a voice for guide or the like related to said image of store, 50, is clearly pronounced from said loudspeaker 22, which can provide an effect of aural advertising to the passers-by and the like, in addition to an effect of visual advertising, through a clear pronunciation of voice.

Thereafter, once the advertisement related to said image of store, 50, is completed, said sheet 3 is further run in the direction of arrow “a” as shown in FIG. 1, the advertisements on the subsequent pages being sequentially bulletined together with an audio guide.

With the bulletining device according to the embodiment of the present invention as described above, the following variety of advantages are obtained.

First, the contents of the advertisement can be explained in detail also with voice to the persons who are interested in the advertisement, which can extremely enhance the effectiveness of the advertisement.

Original posters which have been prepared by individual stores and the like can be changed into posters having an audio capability.

Further, the contents of the advertisement can be easily transmitted with voice to elderly persons, visually handicapped persons, and the like.

Still further, it offers a wide variety of applications, including transmission of regional information, and original advertisement, and allows shortening the time required for replacing of advertisement information and poster with new one, which can lead to substantial time saving. In addition, by attaching a fly-screening glass to said opening 2, the possibility of failure and contamination due to flies and the like can be eliminated.

(Embodiment of the Present Invention for the Second Problem and the Second Purpose)

Hereinbelow, a device for bulletining posters and the like according to an embodiment of the present invention for the second problem and the second purpose will be described in details with reference to FIG. 1, FIG. 2 and FIG. 3, which have been also used in the above description.

The bulletining device according to the present embodiment as shown in FIG. 1, FIG. 2 and FIG. 3 is configured such that, in an opening 2 disposed in the front of a cabinet 1 in the form of a box, for example, a sheet 3 formed in the shape of a strip in a continuous length provided with a variety of information including advertisement information, such as an image of store, 50, together with guide characters 51, on the sheet surface, being divided into a desired number of pages, is presented, and by driving this sheet 3 up or down along the longitudinal direction thereof with a sheet driving means 4 incorporated in the cabinet 1, the variety of information on the sheet surface can be selectably bulletined page by page in the area of said opening 2.

Said sheet driving means 4 comprises rollers 5, 6 disposed in vertically opposed positions in the horizontal direction in FIG. 1 in the top and bottom areas of the inside of the cabinet 1, and a motor 7 connected to one roller 6, said sheet 3 being wound around the rollers 5, 6 and the motor 7 turning the roller 6 to drive said sheet 3 up or down along the opening 2.

A belt transmission mechanism (not shown) is disposed between the rollers 5, 6 for turning the roller 5 and the roller 6 in synchronization. Said roller 5 is provided with a tensioning mechanism 40 later described.

The cabinet 1 is provided with an operation section 21 for carrying out a variety of operations and a loudspeaker 22 as a pronouncing means which are located on the side of the opening 2.

The cabinet 1 is also provided with a page number sensor 24 as a page number detection means for scanning the respective pages on the sheet surface of the sheet 3, and detecting the character data, such as page 1 and page 2, which is previously given.

FIG. 3, as in the previous description, shows a control system for the bulletining device, which has a control section 10 for controlling the entire device by taking in a page number signal read out by the page number sensor 24 which is operated in synchronization with the up or down movement of said sheet 3. In addition, said bulletining device is provided with an illuminating section 26 for illuminating the area of the opening 2 and a power supply/control circuit 28 which powers and controls said motor 7.

The bulletining device comprises a magnetic tape recorder 31 as an audio data recording means which records analog audio data related to said variety of information on the respective pages or other analog audio data; an IC memory 32 as a conversion data recording means which converts analog audio data related to said variety of information or other analog audio data sent from this magnetic tape recorder 31 into digital data, records it as digital audio data, and delivers it to said control section 10; a loudspeaker driving section 33 as an audio signal delivering means which, on the basis of the page number detection signal from said page number sensor 24, reads out the digital audio data for the pertinent page, converts it into an audio signal for delivery; and said loudspeaker 22.

Instead of said magnetic tape recorder 31, a variety of magnetic recording media, such as a magnetic disk (MD) and an IC recorder, which are capable of recording analog audio data may be used.

Instead of said IC memory 32, a variety of recording media, such as a CD-R, a CD-RW, and an MO, which are capable of digital recording may be used.

Further, said bulletining device is provided with a jam sensor 61 which detects jamming of said sheet 3, and a human body sensor 63.

Said operation section 21 comprises a switch section 21A and an indication section 21B, the switch section 21A having a power switch, an advancing switch for advancing a particular area (page) of said sheet 3, a return switch, a stopping switch, a reset switch, an auto/manual selector switch, a page renewing time setting switch, a poster end storing switch, a volume potentiometer (or a volume switch), and the like.

The indication section 21B is provided with LEDs which carry out power-on indication, poster page number indication, error indication and the like.

The present invention may, of course, be carried out with only the component for providing an adequate effect of advertising by appealing to the visual sense being used, and the component for providing an aural effect of advertising by means of said voice pronunciation being eliminated.

Next, said tensioning mechanism 40 will be described with reference to FIG. 4.

This tensioning mechanism 40 comprises a permanent magnet plate 41 with which N and S magnetic poles are alternately provided, and a magnetic substance plate 42, such as an iron plate, which are fixed to the cabinet 1 in proximity of said roller 5 by means of a support piece 43; and a roller side magnetic substance plate 44, such as an iron plate, which is attached to the end of said roller 5 with a minute spacing of “t” being provided from said permanent magnet plate 41, such that the magnetic forces from the respective N and S magnetic poles of the magnetic substance plate 42 act on the roller side magnetic substance plate 44 with no contact and friction, by which a tension in the direction of arrow “d”, which is opposite to the direction of arrow “c”, is always applied to the sheet 3 through said roller 5.

With this configuration, occurrence of slacks in said sheet 3 is prevented by the tension in the direction of arrow “d”, which results in the sheet 3 being always stretched, and thus allows the image of store, 50, and the like to be visually identified with exactness.

In place of the permanent magnet plate 41 in said tensioning mechanism 40, an electromagnet (not shown) can be used, and in this case, it is, of course, possible to provide a configuration with which the current for the electromagnet can be changed for adjusting the electromagnetic force to act on the roller side magnetic substance plate 44, and thus the tension to be applied to the sheet 3 in the direction of arrow “d”, which is opposite to the direction of arrow “c”.

With the bulletining device according to the present embodiment, turning the power switch provided in the switch section 21A of said operation section 21, and then turning the advancing switch on will activate the power supply/control circuit 28, drive the motor 7, and run said sheet 3 in the direction of arrow “a” as shown in FIG. 1 under the control of the control section 10, by which said image of store, 50, and the guide characters 51 are displayed in the opening 2, an audio data recording section 23 being also run in the direction of arrow “a”

At the same time, said sensor 24 scans the respective pages on the sheet surface of the sheet 3 for the character data, such as page 1 and page 2, which is previously given, and delivers the page number signal to the control section 10.

On the other hand, the analog audio data related to said variety of information or other analog audio data sent from said magnetic tape recorder 31 is recorded as digital audio data by the IC memory 32.

In accordance with the control by said control section 10, the loudspeaker driving section 33 reads out the digital audio data for the pertinent page from the IC memory 32 on the basis of the page number detection signal from said page number sensor 24, and converts it into an audio signal for delivering it to the loudspeaker 22.

As a result of this, a voice for guide or the like related to said image of store, 50, is clearly pronounced from said loudspeaker 22, which can provide an effect of aural advertising to the passers-by and the like, in addition to an effect of visual advertising, through a clear pronunciation of voice.

In this case, said tensioning mechanism 40 always applies a tension in the direction of arrow “b” (“c” in FIG. 4), which is opposite to the direction of arrow “a” (“d” in FIG. 4), to the sheet 3 through said roller 5, therefore, in bulletining a variety of information including advertisement information attached to the sheet 3 in a continuous length in the area of the opening 2 of the cabinet 1, slackening of the sheet surface is prevented, which allows an adequate effect of advertising by appealing to the visual sense to be provided.

Thereafter, once the advertisement related to said image of store, 50, is completed, said sheet 3 is further run in the direction of arrow “a” as shown in FIG. 1, the advertisements on the subsequent pages being sequentially bulletined together with an audio guide.

With the bulletining device according to the embodiment of the present invention as described above, the following variety of advantages are obtained.

First, the contents of the advertisement can be explained in detail also with voice to the persons who are interested in the advertisement, which can extremely enhance the effectiveness of the advertisement.

Original posters which have been prepared by individual stores and the like can be changed into posters having an audio capability.

Further, the contents of the advertisement can be easily transmitted with voice to elderly persons, visually handicapped persons, and the like.

Still further, it offers a wide variety of applications, including transmission of regional information, and original advertisement, and allows shortening the time required for replacing of advertisement information and poster with new one, which can lead to substantial time saving. In addition, by attaching a fly-screening glass to said opening 2, the possibility of failure and contamination due to flies and the like can be eliminated.

As stated above, the present invention can, of course, be carried out with only the component for providing an adequate effect of advertising by appealing to the visual sense being used, and the component for providing an aural effect of advertising by means of said voice pronunciation being eliminated.

(Embodiment of the Present Invention for the Third Problem and the Third Purpose)

Hereinbelow, a device for bulletining posters and the like according to an embodiment of the present invention for the third problem and the third purpose will be described in details.

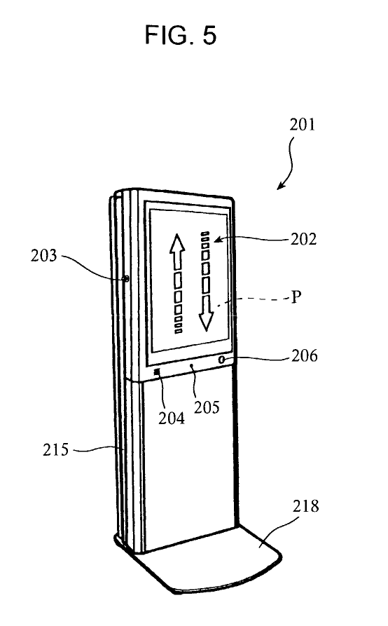

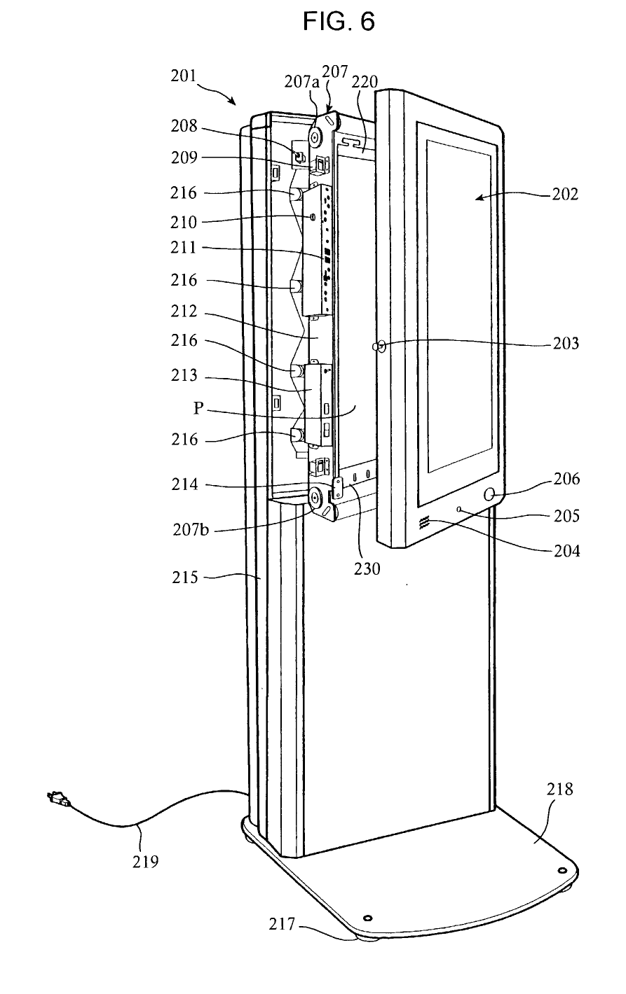

As shown in FIG. 5 and FIG. 6, with the device for bulletining posters and the like according to the present embodiment, a front cover 202 which allows visual identification of a poster or the like, P, bulletined inside of a device main body 201 is provided in the front central portion of said device main body 201, which is in the shape of a rectangular parallelepiped, for example.

On the left side of the front cover 202, a front cover opening/closing key 203 is provided.

In the front lower portion of the front cover 202 in the device main body 201, a loudspeaker 204, a human body sensor 205 which senses the existence of a human body, and a return pushbutton switch 206 are provided.

Inside of said device main body 201, a support unit 207 for supporting a desired number of posters or the like, P, and on the side of this support unit 207, a frequency selector switch 208, a mechanical unit opening/closing knob 209, a chime sound potentiometer 210, an operation panel 211, a mechanical unit 212, a power/illumination switch 213, and a position sensor 214 which detects the position of said desired number of posters or the like, P, are disposed.

Further, on the rear side of the support unit 207, a column or support frame 215 which constitutes the entire framework of the device main body 201 of the device for bulletining posters and the like is disposed, and on the back of the support unit 207, internal illuminators 216, such as fluorescent lamps, are disposed.

At the bottom of said device main body 201, a flat base 218 equipped with adjusters 217 is provided. Further, a power cord 219 is connected to the device main body 201.

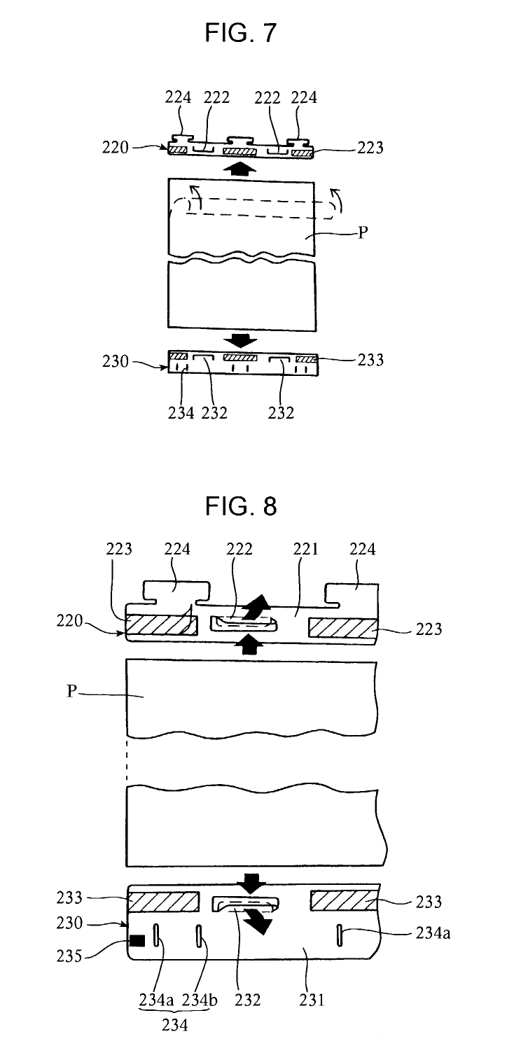

Next, with reference to FIG. 7 and FIG. 8, a construction for connecting a desired number of posters or the like, P, with an upper connection sheet 220 and a lower connection sheet 230 will be described.

The upper connection sheet 220 comprises a sheet main body 221 formed in an approximately rectangular shape that is made of a thin sheet having an elasticity, for example, with two positioning stoppers 222 which are capable of being opened and closed, serving to stop and position the upper edge of the poster or the like, P, in the longitudinal direction, and a pasting portion 223 in, say, three places consisting of a double-sided adhesive tape which is to be pasted to the upper edge back surface of the poster or the like, P.

Further, at the upper edge of said sheet main body 221 are provided a flexible engaging piece 224 in, say, three places that has an approximately T shape, serving to engage for connection with the upper leader sheet to be disposed thereabove or the poster or the like, P, to be disposed thereabove.

The lower connection sheet 230 comprises a sheet main body 231 formed in an approximately rectangular shape that is made of a thin sheet having an elasticity, for example, with two positioning stoppers 232 which are capable of being opened and closed, serving to stop and position the lower edge of the poster or the like, P, in the longitudinal direction, and a pasting portion 233 in, say, three places consisting of a double-sided adhesive tape which is to be pasted to the lower edge back surface of the poster or the like, P.

Further, in the lower portion of said sheet main body 231 are provided an engaging hole 234 in, say, three places that serves to engage for connection with the lower leader sheet to be disposed thereunder or the poster or the like, P, to be disposed thereunder, more particularly, with which said engaging piece 224 is capable of being engaged. In correspondence with the geometry of the engaging piece 224 which has an approximately T shape, the engaging hole 234 in three places is comprised of a pair of slits 234a, 234b, having a defined spacing between them.

Further, to the lower left portion of the lower connection sheet 230 is attached a sensor marking 235 which is detected by said positioning sensor 214. Alternatively, the sensor marking 235 may be attached to the upper connection sheet 220 instead of being attached to the lower connection sheet 230.

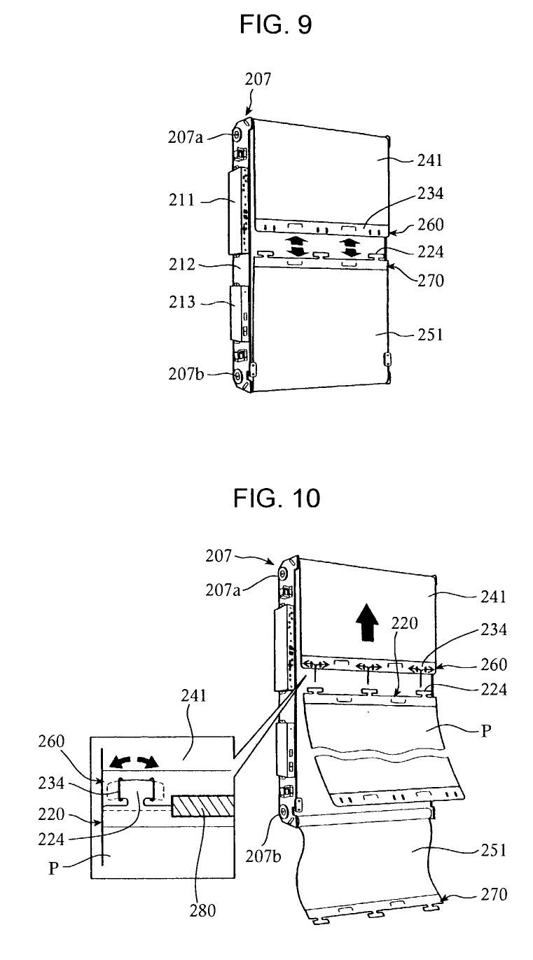

Further, said support unit 207 supports an upper leader sheet 241 and a lower leader sheet 251 which are disposed in the upper and lower positions, respectively, as shown in FIG. 9 and the like.

Said upper leader sheet 241 is driven to be wound up or unwound by an upper winding section 207a provided at the top of the support unit 207, and the lower leader sheet 251 is driven to be wound up and unwound by a lower winding section 207b provided at the bottom of the support unit 207.

At the edge of the above-mentioned upper leader sheet 241 is mounted an upper leader sheet bottom connection sheet 260 which has the same construction as that of said lower connection sheet 230, and at the edge of the lower leader sheet 251 is mounted a lower leader sheet top connection sheet 270 which has the same construction as that of said lower connection sheet 220.

When no posters or the like, P, are loaded, the upper leader sheet 241 and the lower leader sheet 251 are connected to each other by means of the upper leader sheet bottom connection sheet 260 and the lower leader sheet top connection sheet 270 as shown in FIG. 9.

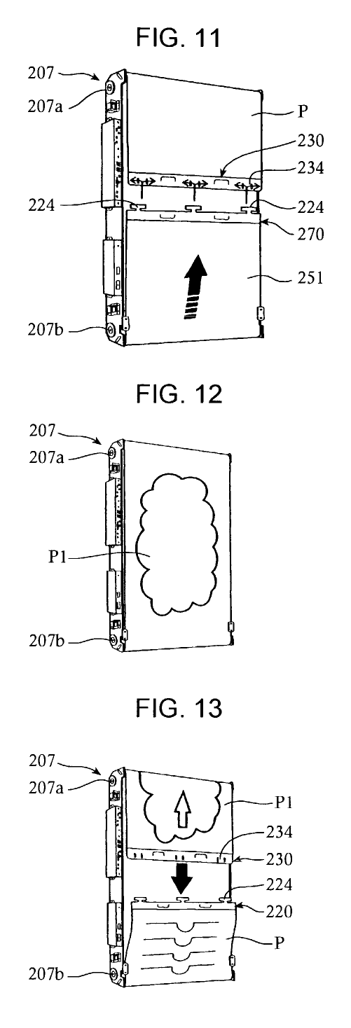

Next, the action of the device for bulletining posters and the like according to the present embodiment that is configured as above for connection of a desired number of posters or the like, P, will be described with reference to FIG. 9 to FIG. 16.

(Loading of Poster or the Like, P)

First, with reference to FIG. 7, FIG. 8, and FIG. 9 to FIG. 11, the operation for loading of a poster or the like, P, will be described.

(1) Pasting of Upper Connection Sheet 220

The poster or the like, P, is straighten out, and with the surface of the upper connection sheet 220 that has the pasting portions 223 being placed facing the back surface of the poster or the like, P, the upper edge of the poster or the like, P, is inserted into the positioning stopper 222 until restricted as shown in FIG. 7 and FIG. 8. In this case, the positioning stopper 222 must be on the front side of the poster or the like, P.

Then, the right and left edges of the poster or the like, P, are aligned with those of the upper connection sheet 220 for positioning the poster or the like, P, and the back surface of the poster or the like, P, is pressed against the upper connection sheet 220 for pasting the back surface of the poster or the like, P, to the upper connection sheet 220 by means of the three pasting portions 223.

(2) Pasting of Lower Connection Sheet 230

The poster or the like, P, is straighten out, and with the surface of the lower connection sheet 230 that has the pasting portions 233 being placed facing the back surface of the poster or the like, P, the lower edge of the poster or the like, P, is inserted into the positioning stopper 232 until restricted as shown in FIG. 7 and FIG. 8. In this case, the positioning stopper 232 must be on the front side of the lower portion of the poster or the like, P.

Then, the right and left edge of the poster or the like, P, is aligned with those of the upper connection sheet 230 for positioning the poster or the like, P, and the back surface of the poster or the like, P, is pressed against the upper connection sheet 230 for pasting the back surface of the poster or the like, P, to the lower connection sheet 230 by means of the three pasting portions 233.

Said lower connection sheet 230 is disposed such that the sensor marking 235 is located on the left side of the poster or the like, P.

(3) Loading of Poster or the Like, P, on Device for Bulletining Posters and the Like

By turning the front cover opening/closing key 203 on the left side of the front cover 202 on the front side of the device main body 201, the front cover 202 is opened.

Then, as shown in FIG. 9, the upper leader sheet 241 and the lower leader sheet 251 are disconnected from each other, more particularly, the upper leader sheet bottom connection sheet 260 and the lower leader sheet top connection sheet 270 are disconnected from each other to hang down the lower leader sheet 251 as shown in FIG. 10.

In this condition, the power is turned on for operating said upper winding section 207a to bring the upper leader sheet 241 to a position where the loading operation can be easily carried out.

Then, as shown in FIG. 10, the poster or the like, P, to which the upper connection sheet 220 has been pasted as described in (1) above is at hand, and the engaging piece 224 in said sheet main body 221 is flexed with fingers to be engaged with the engaging hole 234 in the upper leader sheet bottom connection sheet 260 for said upper leader sheet 241, and then released from the flexed state.

Then, as shown in a partially enlarged view in FIG. 10, the engaging piece 224 is spread toward both sides through the engaging hole 234, the poster or the like, P, being connected to the upper leader sheet 241 through the upper connection sheet 220 and the upper leader sheet bottom connection sheet 260.

In this case, if the poster or the like, P, is to be bulletined for a long period of time, an adhesive tape 80 is preferably applied to the joint as shown in a partially enlarged view in FIG. 10.

Thus, after connecting the poster or the like, P, to the upper leader sheet 241, said upper winding section 207a may be operated to move the poster or the like, P, for connecting the upper edge of a subsequent poster or the like, P, to the lower edge of the poster or the like, P.

More particularly, the engaging piece 224 for the upper connection sheet 220 for a subsequent poster or the like, P, may be flexed with fingers to be engaged with the engaging hole 234 in the lower connection sheet 230 for the poster or the like, P, located above for connecting the posters or the like, P, to each other.

After loading a desired number of (one, two, three or more) posters, the poster or the like, P, at the tail end is connected to the lower leader sheet 251 by engaging the engaging piece 224 for the lower leader sheet top connection sheet 270 for the lower leader sheet 251 with the engaging hole 234 in the lower connection sheet 230 pasted to the poster or the like, P, at the tail end.

Thus, a desired number of (one, two, three or more) posters or the like, P, can be simply and continuously disposed between the upper leader sheet 241 and the lower leader sheet 251 with no need for using a base sheet as mentioned in the paragraph under the title of prior art.

(4) Replacing of Poster with New One

Next, the operation for replacing a specific poster or the like, P, of a desired number of (one, two, three or more) posters or the like, P, which are connected to one another by the connection scheme as stated above will be described with reference to FIG. 12 to FIG. 16.

By turning the front cover opening/closing key 203 on the left side of the front cover 202 on the front side of the device main body 201, the front cover 202 is opened.

Then, the power is turned on, and the posters or the like, P, are moved in sequence to bring the poster or the like, P1, to be unloaded (replaced with new one) to the front of the support unit 207 as shown in FIG. 12.

Then, the posters or the like, P, are moved upward to bring the lower end of the poster or the like, P1, to be unloaded (replaced with new one) to a position where the disconnecting operation can be easily carried out, as shown in FIG. 13.

In this condition, from the engaging hole 234 in the lower connection sheet 230 which is adhered to the lower end of the poster or the like, P1, to be unloaded (replaced with new one), the engaging piece 224 for the upper connection sheet 220 adhered to the upper end of the subsequent poster or the like, P, is disengaged as shown in FIG. 13.

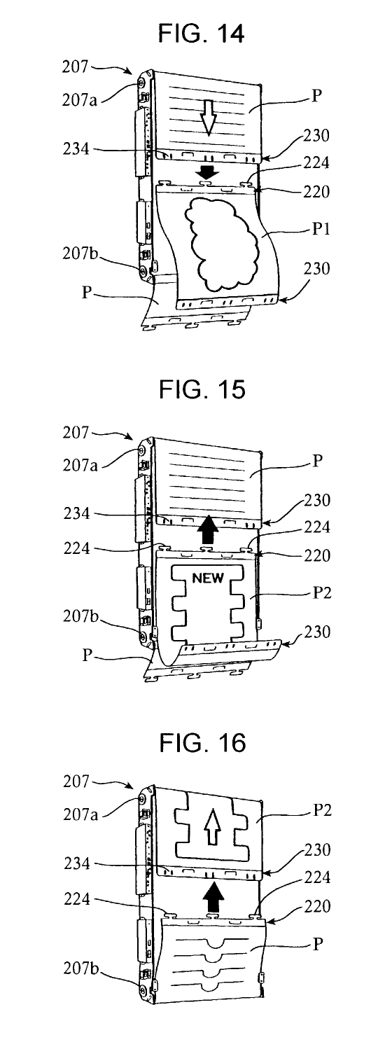

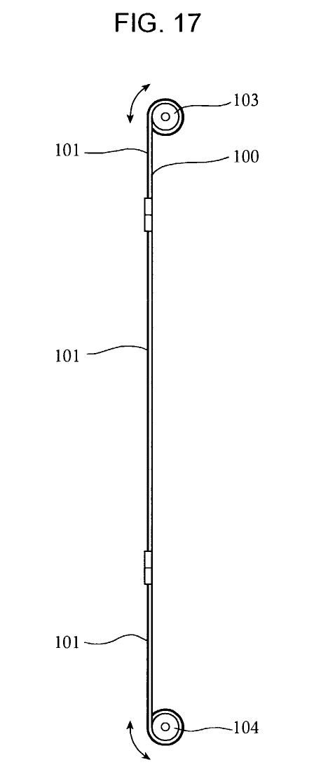

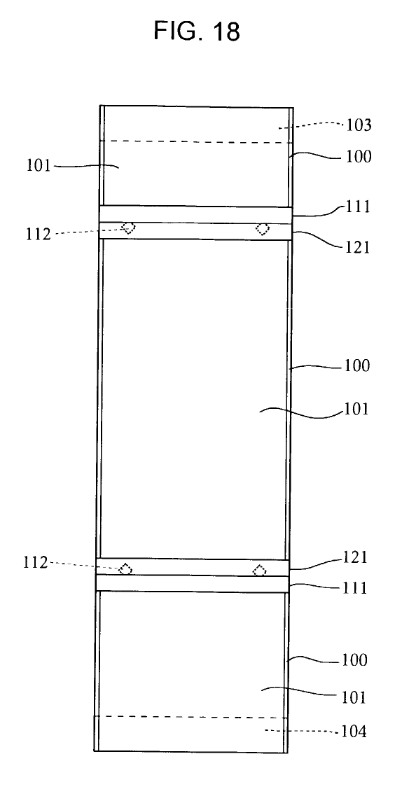

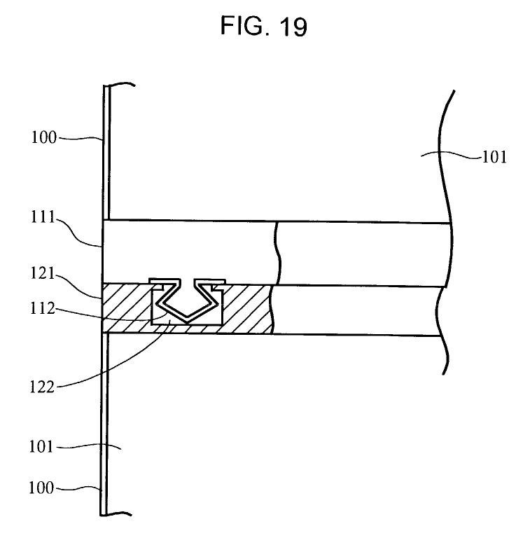

Then, as shown in FIG. 14, the poster or the like, P1, to be unloaded (replaced with new one) is moved downward, and the engaging piece 224 for the upper connection sheet 220 adhered to the upper end of the pertinent poster or the like, P1, is disengaged from the engaging hole 234 in the lower connection sheet 230 which is adhered to the lower end of the preceding poster or the like, P.

By doing this, said poster or the like, P1, to be unloaded (replaced with new one) is brought into the free state, and thus can be removed from the support unit 207.

Then, as shown in FIG. 15 and FIG. 16, a new poster or the like, P, to which an upper connection sheet 220 and a lower connection sheet 230 are pasted is connected to the preceding and subsequent posters or the like, P, in the same manner as stated above.

More particularly, a new poster or the like, P2, for example, is at hand, and the engaging piece 224 in said sheet main body 221 is flexed with fingers to be engaged with the engaging hole 234, and then released from the flexed state.

Then, said poster or the like, P2, to be newly loaded is fed upward to bring the lower end thereof to a position where the connecting operation can be easily carried out, as shown in FIG. 16, and the engaging piece 224 for the upper connection sheet 220 adhered to the upper end of the subsequent poster or the like, P, is engaged with the engaging hole 234 in the lower-connection sheet 230 which is adhered to the lower end of the poster or the like, P2.

By doing this, the new poster or the like, P2, is loaded, being connected to the subsequent poster or the like through the upper connection sheet 220 and the lower connection sheet 230.

Through the above-stated sequence of operations, replacement of the poster or the like, P, with a new one can easily be carried out.

The inventions as defined in claims 1 and 2 can provide a device of a novel configuration for bulletining posters and the like with which, in addition to the effect of advertising by appealing to the visual sense of a large number of unspecified persons, such as passers-by, the effect of advertising by appealing to the aural sense can be enhanced with an explanation by voice being made possible, resulting in the effect of labor saving being also created, and the effect of the advertisement being improved. In addition, by previously recording advertisement information or the like on the magnetic recording medium by voice, the voice related to the respective page or other voice can be clearly transmitted to the passers-by and the like. Thus, with the above-mentioned first problem being solved, the above-mentioned first purpose of the present invention can be achieved.

The invention as defined in claim 3 can provide a device for bulletining posters and the like with which slackening of the sheet surface is prevented, and thus an adequate effect of advertising by appealing to the visual sense of a large number of unspecified persons, such as passers-by, can be created. Thus, with the above-mentioned second problem being solved, the above-mentioned second purpose of the present invention can be achieved.

The invention as defined in claim 4 can provide a device for bulletining posters and the like with which slackening of the sheet surface is prevented, and thus an adequate effect of advertising by appealing to the visual sense of a large number of unspecified persons, such as passers-by, can be created, and with which an effect of advertising by appealing to the aural sense can also be created. Thus, with the above-mentioned second problem being solved, the above-mentioned second purpose of the present invention can be achieved.

The inventions as defined in claims 5, 6, and 7 can provide a device for bulletining posters and the like with which a desired number of posters or the like can be freely connected to one another or replaced with a new one by using the upper connection sheet and lower connection sheet having the above-stated configuration; and the configuration is simple with no need for using a base sheet, the individual posters or the like being able to be mounted with an easy mounting operation for bulletining, and the replacement thereof with a new one being able to be carried out with ease. Further, according to the inventions as defined in claims 5, 6, and 7, the simple configuration eliminates the need for using a base sheet, therefore a desired number of posters or the like can be connected to one another with ease, and yet, if an unnecessary poster or the like is unloaded, there is no possibility of a blank portion being produced. Thus, with the above-mentioned third problem being solved, the above-mentioned third purpose of the present invention can be achieved.

The invention as defined in claim 8 can easily carry out detection of the positions of the posters or the like in addition to the effects of the inventions as defined in claims 5, 6, and 7.

What is claimed is:

1. A device for bulletining posters and the like with which a sheet in a continuous length having a variety of information including advertisement information on respective pages on the sheet surface is presented in an opening provided in a cabinet, and this sheet is driven with sheet driving means along the longitudinal direction thereof for bulletining the variety of information on the respective pages in the area of said opening, comprising:
page number detection means for detecting page number on said sheet surface;
audio data recording means which records analog audio data related to said variety of information on the respective pages or other analog audio data;
conversion data recording means which converts analog audio data related to the variety of information or other analog audio data sent from the audio data recording means into digital data, and records it as digital audio data;
audio signal delivering means which, on the basis of page number detection signal from said page number detection means, reads out the digital audio data from the conversion data recording means, and delivers it as an audio signal; and
pronouncing means which, on the basis of the audio signal from the audio signal delivering means, pronounces voice related to the pertinent page or other voice.

2. A device for bulletining posters and the like as claimed in claim 1, wherein said audio data recording means is recording means provided with a magnetic recording medium which stores voice as analog data, and said conversion data recording means is an IC memory which converts analog audio data into digital audio data, and records it.

3. A device for bulletining posters and the like with which a sheet in a continuous length having a variety of information including advertisement information on the sheet surface is presented in an opening provided in a cabinet, and this sheet is supported, being stretched across a pair of rollers provided inside on both sides of the opening in said cabinet, with one roller being turned by a roller driving section for driving the sheet in the longitudinal direction thereof such that the variety of information on respective pages is bulletined in the region of said opening for visual guidance,
wherein is provided a tensioning mechanism which comprises a permanent magnet plate with which N and S magnetic poles are alternately provided, and a magnetic substance plate which are fixed in proximity of the other of said pair of rollers; and a roller side magnetic substance plate which is attached to the end of said roller with a minute spacing from said permanent magnet plate being provided, such that forces in the direction which is opposite to the direction of sheet driving always act on the other roller of said pair of rollers for applying a tension to said sheet.

4. A device for bulletining posters and the like with which a sheet in a continuous length having a variety of information including advertisement information on the sheet surface is presented in an opening provided in a cabinet, and this sheet is supported, being stretched across a pair of rollers provided inside on both sides of the opening in said cabinet, with one roller being turned by a roller driving section for driving the sheet in the longitudinal direction thereof such that the variety of information on respective pages is bulletined in the region of said opening for aural guidance,
wherein is provided a tensioning mechanism which comprises a permanent magnet plate with which N and S magnetic poles are alternately provided, and a magnetic substance plate which are fixed in proximity of the other of said pair of rollers; and a roller side magnetic substance plate which is attached to the end of said roller with a minute spacing from said permanent magnet plate being provided, such that forces in the direction which is opposite to the direction of sheet driving always act on the other roller of said pair of rollers for applying a tension to said sheet.

5. A device for bulletining posters and the like, wherein an upper connection sheet having a plurality of positioning stoppers formed in an approximately rectangular shape for positioning the upper edge of a poster or the like, a plurality of pasting portions which are to be pasted to the upper edge back surface of the poster or the like, and a plurality of engaging pieces for engaging for connection with an upper leader sheet to be disposed thereabove or the poster or the like to be disposed thereabove; and
a lower connection sheet having a plurality of positioning stoppers formed in an approximately rectangular shape for positioning the lower edge of a poster or the like, a plurality of pasting portions which are to be pasted to the lower edge back surface of the poster or the like, and a plurality of engaging holes for engaging for connection with a lower leader sheet to be disposed thereunder or the poster or the like to be disposed thereunder;
are mounted to the upper edge and the lower edge of an individual poster or the like, a desired number of posters or the like being disposed between the upper leader sheet and the lower leader sheet such that they can be replaced with a new one, and by winding up the upper leader sheet or the lower leader sheet, said posters or the like are raised or lowered for bulletining.

6. A device for bulletining posters and the like as claimed in claim 5, wherein said upper connection sheet comprises a sheet main body made of a thin sheet formed in an approximately rectangular shape; has a plurality of positioning stoppers which are capable of being opened and closed, serving to stop and position the upper edge of the poster or the like in the longitudinal direction; comprises a plurality of pasting portions each consisting of a double-sided adhesive tape which is to be pasted to the upper edge back surface of the poster or the like; and at the upper edge of the sheet main body, provides a plurality of flexible engaging pieces which have an approximately T shape, serving to engage for connection with the upper leader sheet to be disposed thereabove or the poster or the like to be disposed thereabove; and
said lower connection sheet comprises a sheet main body made of a thin sheet formed in an approximately rectangular shape; has a plurality of positioning stoppers which are capable of being opened and closed, serving to stop and position the lower edge of the poster or the like in the longitudinal direction; comprises a plurality of pasting portions each consisting of a double-sided adhesive tape which is to be pasted to the lower edge back surface of the poster or the like; and in the lower portion of the sheet main body provides a plurality of engaging holes which serve to engage for connection with the lower leader sheet to be disposed thereunder or the poster or the like to be disposed thereunder, more particularly, with which said engaging pieces of the upper connection sheet are capable of being engaged, with the plurality of engaging holes each being comprised of a pair of slits having a defined spacing between them in correspondence with the geometry of said engaging piece for the upper connection sheet that has an approximately T shape.

7. A device for bulletining posters and the like as claimed in claim 5 or 6, wherein said upper leader sheet is provided with engaging holes with which the engaging pieces for the upper connection sheet are to be engaged, and said lower leader sheet is provided with engaging pieces which are to be engaged with the engaging holes in the lower connection sheet.

8. A device for bulletining posters and the like as claimed in any one of the claims 5 to 7, wherein, to said upper connection sheet or said lower connection sheet is attached a sensor marking which is detected by a positioning sensor disposed in the device main body for detection of the positions of the posters or the like.
